(19) United States
(12) Patent Application Publication
(10) Pub. No.: US 2009/0188623 A1
(43) Pub. Date: Jul. 30, 2009

(54) SEPARATING SLIP-SHEETS FROM IMAGE RECORDABLE MATERIAL

(76) Inventors: Alan B. Gordon, Richmond (CA); Gordon D. Andrew, Delta (CA); Christopher G. Morley, Vancouver (CA)

Correspondence Address: J. Lanny Tucker;Patent Legal Staff, Eastman Kodak Company, 343 State Street, Rochester, NY, 14650-2201, US

(21) Appl. No.: 12/047,352

(22) Filed: Mar. 13, 2008

Related U.S. Application Data
(63) Continuation-in-part of application No. 12/021,358, filed on Jan. 29, 2008, now abandoned.

(51) Int. Cl. B32B 38/10

(52) U.S. Cl. 156/344; 156/584

(57) ABSTRACT

A method for separating a slip-sheet 40B from an image recording medium (17B) comprises: bringing a slip-sheet picker (55) into contact with the slip-sheet (410), a first part of the slip-sheet picker exerting pressure on the image recordable material at a first point; exerting with a retraction roller (230) portion of the slip-sheet picker pressure on the slip-sheet at a second point; folding the slip-sheet (420) in a confined space between the slip-sheet picker and the image recordable media by rotating the retraction roller; and capturing the slip-sheet (450) by rotating the retraction roller.

### CROSS REFERENCE TO RELATED APPLICATIONS

This is a Continuation-in-Part of application Ser. No. 12/021,358, filed Jan. 29, 2008, entitled SEPARATING SLIP-SHEETS FROM IMAGE RECORDABLE MATERIAL, by Gordon et al.

### FIELD OF THE INVENTION

This invention relates to the field of imaging systems and more particularly to the field of separating slip-sheets and image recordable materials from a media stack made up of an interleaved plurality of image recordable materials and slip-sheets.

### BACKGROUND OF THE INVENTION

In the commercial printing industry, an important step in the preparation of images for printing is the transfer of image information to an image recordable material that can be used repeatedly to print the image. While the image recordable material can take a variety of forms, one common form is the printing plate that includes a surface that can be modified in an image-wise fashion.

Printing plates can take different forms. In one embodiment the modifiable surface includes a special coating referred to as an emulsion. An emulsion is a radiation sensitive coating that changes properties when exposed to radiation such as visible, ultraviolet, or infrared light. An emulsion can include one or more layers that are coated onto a substrate, which can be composed of a variety of materials such as aluminum, polyester or elastomers.

The transfer of image information to an image recordable material can be done in a variety of methods. One method in which image information is transferred to an image forming material is by computer-to-plate (CTP) systems. In CTP systems images are formed on the modifiable surface of an image recordable material by way of radiation beams or the like, generated by an imaging head in response to image forming information. In this manner, images are quickly formed onto the image recordable material.

The advent of CTP technology is part of an increasing trend towards automation in the printing industry. The increasing use of information technology to create and distribute electronic and print publications, coupled with the more widespread accessibility of such technologies is contributing to a greater demand for shorter print runs and faster turnaround times. These changes, in turn, have contributed to a greater push towards automating all aspects of the printing process.

Automating the printing industry does present some special technological hurdles, however. In the case of printing plates used in CTP systems, some of these hurdles result from the delicacy of the modifiable surfaces of these plates. These plates are easily marred, and if marred, can create undesirable defects in the final printed product. Any attempt to automate the handling of printing plates must include measures to prevent damage to the delicate modifiable surfaces of the plates.

Measures used to reduce marring of printing plates during storage or transport, however, introduce additional problems for automation. Unexposed printing plates are normally supplied in packages in numbers that can range from a few dozen to several hundred, with slip-sheets interspersed between adjacent printing plates. Slip-sheets are used to protect the sensitive surfaces of the printing plates by providing a physical barrier between printing plates. The slip-sheets must be removed from the printing plates prior to imaging.

The automation of slip-sheet removal and storage presents a number of challenges. Slip-sheet removal is not simply a matter of moving a single sheet from a stack of similar sheets. In general, slip-sheets are made from materials different from those used for printing plates (e.g. paper) and in particular, from materials which do not damage the modifiable surfaces of the printing plates. Separating a slip-sheet from an adjacent plate can be complicated when the slip-sheet becomes adhered to a surface of the adjacent plate by physical mechanisms that can include electrostatic attraction or the expulsion of air between the surfaces. These mechanisms can lead to multiple plate picks that can lead to system error conditions. Increasing plate-making throughput requirements complicate matters further by necessitating that the slip-sheets be removed at rates that do not hinder the increased plate supply demands.

Conventional materials pickers have typically picked and removed printing plates and slip-sheets sequentially from a media stack. For example, in some conventional systems, a slip-sheet is first picked from the media stack and moved to a disposal container. Once the slip-sheet has been moved, a printing plate is then picked and moved to subsequent station where it is processed (e.g. imaging in an exposure engine). In other conventional systems, a slip-sheet is picked and transferred to a disposal container after the printing plate has been secured and transferred to a subsequent process. In either case, the sequential picking and removal steps can adversely affect the overall system throughput times. Reduced throughput can also arise when additional efforts are expended to secure an additional sheet that is adjacent to a given sheet that is being removed from the media stack. In such a case, these efforts are required to prevent the additional sheet from being removed accidentally along with the given sheet.

Some conventional systems attempt to remove slip-sheets and printing plates simultaneously from a media cassette and convey them to a second location to be separated. In these conventional systems, suction is drawn through a porous slip-sheet to secure an underlying printing plate. Different slips-sheets can have different degrees of porosity that can affect the picking reliability of the underlying plate. The slip-sheet is removed from the printing plate at some later point along the conveying path.

The presence of slip-sheets can hinder automation associated with the processing of image recordable materials. Although slip-sheets are typically added to prevent damage to the modifiable surfaces of printing plates while the plates are arranged in media stacks, the separation of the slip-sheets from the printing plates must be performed in a manner that minimizes damage to modifiable surfaces that the slip-sheets are trying to protect. Consequently, there remains a need for better methods for separating image recordable materials from a media stack that includes an interleaved assemblage of image recording materials and slip-sheets. In particular, the matter of removing a slip-sheet that adheres to a planar surface of a printing plate remains a challenge.

### SUMMARY OF THE INVENTION

Briefly, according to one aspect of the present invention a method for separating a slip-sheet from an image recording medium comprises: bringing a slip-sheet picker into contact with the slip-sheet, a first part of the slip-sheet picker exerting pressure on the image recordable material at a first point; exerting with a retraction roller portion of the slip-sheet picker pressure on the slip-sheet at a second point; folding the slip-sheet in a confined space between the slip-sheet picker and the image recordable media by rotating the retraction roller; and capturing the slip-sheet by rotating the retraction roller.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

In drawings which show a non-limiting example embodiment of the invention:

FIG. 1 shows a schematic representation of an image recoding system;

FIG. 2a shows a schematic cross-sectional view of a slip-sheet picker in contact with a slip-sheet on an image recordable material;

FIG. 2b shows the initiation of folding of a slip-sheet on an image recordable material being retracted by a slip-sheet picker;

FIG. 2c shows the capturing of a slip-sheet on an image recordable material by a slip-sheet picker;

FIG. 3 shows a schematic cross-sectional view of a slip-sheet picker in contact with a slip-sheet on an image recordable material; and

FIG. 4 shows a schematic flow diagram of a method for separating a slip-sheet from an image recordable material.

### DETAILED DESCRIPTION OF THE INVENTION

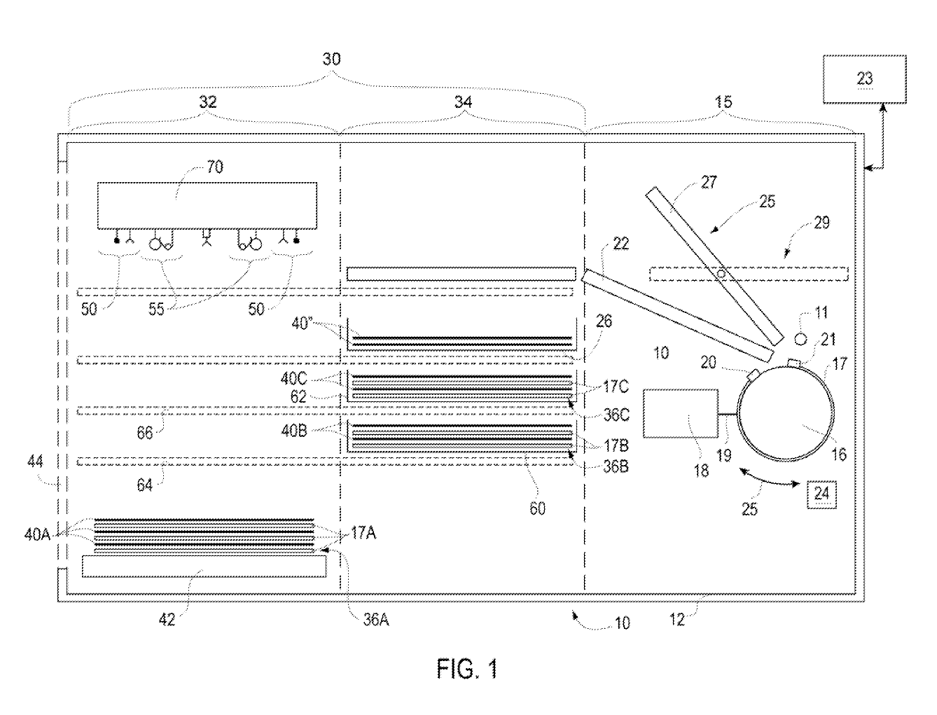

FIG. 1 schematically shows an image recording system 10. The image recording system 10 includes an exposure system 15 and a materials handling system 30. In this embodiment, exposure system 15 and materials handling system 30 form an integrated system enclosed by housing 12.

Exposure system 15 includes an exposure support 16 to mount an image recordable material 17 thereupon and an imaging head 18 disposed to emit radiation beams 19 to form an image on the image recordable material 17. Materials handling system 30 includes, among other things, a picking assembly 70. Picking assembly 70 and image recordable materials pickers 50 (herein referred to as “materials pickers 50”) to secure and transport image recordable materials 17A, 17B, and 17C respectively from one or more media stacks 36A, 36B, and 36C of image forming materials 17A, 17B, and 17C and transport the secured image recordable materials 17A, 17B, and 17C to exposure system 15. Picking assembly 70 includes slip-sheet picker 55 to secure slip-sheets 40A, 40B, and 40C respectively from one or more media stacks 36A, 36B, and 36C and transport them to a slip-sheet holder 26. In this embodiment, materials pickers 50 and slip-sheet pickers 55 are combined to form an integrated picking assembly 70.

Exposure support 16 is an external cylindrical drum. Other types of exposure supports such as, for example, internal drums and flatbed configurations can be used. Image recordable material 17 is secured onto exposure support 16 by leading edge clamps 20 and trailing edge clamps 21. Image recordable material 17 is conveyed onto exposure support 16 with the assistance of loading support 22 and roller 11. During loading, exposure support 16 is appropriately positioned, and leading edge clamps 20 are activated by an associated actuator (not shown) to accept image recordable material 17. Loading support 22 is used to support image recording material 17 as its leading edge is introduced into leading edge clamps 20. Image recordable material 17 can be aligned with respect to exposure support 16 by abutting its leading edge against one or more registration features (not shown) that are positioned in a pre-determined orientation with respect to exposure support 16. Leading edge clamps 20 are activated to secure the leading edge of image recordable material 17 with respect to exposure support 16. Exposure support 16 is rotated to wrap image recordable material 17 on exposure support 16. Roller 11 is activated to ensure contact between image recordable material 17 and exposure support 16 during the wrapping. Exposure support 16 is rotated to a predetermined position wherein trailing edge clamps 21 are activated by an associated actuator (not shown) to secure the trailing edge of image recordable material 17 against exposure support 16.

Other known systems for mounting image recordable material 17 onto exposure support 16 can also be used such as, for example, suction may be applied through various features formed on the surface of exposure support 16 to assist in securing image recordable material 17 to exposure support 16. Other known systems can be used to align image recordable material 17 with respect to exposure support 16. Controller 23 is used to manage, create and/or modify digital files representing images to be formed on image recordable material 17. Controller 23 can also include a raster image processor to further process the digital files into image information that includes raster data. Controller 23 can provide device control signals to control the various required functions of exposure system 15 and materials handling system 30. Various systems can be controlled using various control signals and/or implementing various methods programmed within controller 23. Controller 23 can be configured to execute suitable software and can include one or more data processors, together with suitable hardware, including by way of non-limiting example: accessible memory, logic circuitry, drivers, amplifiers, A/D and D/A converters, input/output ports and the like. Controller 23 can comprise, without limitation, a microprocessor, a computer-on-a-chip, the CPU of a computer or any other suitable microcontroller. Controller 23 can be associated with a materials handling system, but need not necessarily be, the same controller that controls the operation of the imaging systems. Controller 23 can be programmed to perform a method as described herein. Image information and control signals provided by controller 23 are used to cause imaging head 18 to generate one or more radiation beams 19 to form an image on image recordable material 17.

In this embodiment, exposure support 16 is rotated by drive 24 during imaging. Imaging head 18 can image a swath of data during each rotation. Drive 24 can rotate exposure support 16 clockwise or counterclockwise as required along a main-scan direction 25. Imaging head 18 is mounted onto a carriage (not shown) that moves along sub-scan direction that is substantially parallel with an axis of rotation of exposure support 16. Imaging head 18 can move along the sub-scan direction while exposure support 16 moves along main-scan direction 25 to create imaged swaths that are helical in form. Alternatively, the motion of imaging head 18 and exposure support 16 can be controlled to image “ring-like” swaths or spiral swaths. This invention is not limited to this exposure system and other exposure systems that employ different control systems and schemes can be used.

When an image has been formed on image recordable material 17, image recordable material 17 is unloaded onto unloading support 27. Image recordable material 17 is unloaded from exposure support 16 by employing the steps of the media loading procedure described above but substantially in reverse sequence, and by correctly positioning exposure support 16 to unload image recordable material 17 onto unloading support 27. Unloading support 27 is movable from a first position 25, at which the image recordable media is unloaded to a second position 29 (shown in broken lines). At second position 29, the unloaded image recordable material 17 can be additionally processed, or conveyed for additional processing.

Materials handling system 30 includes a primary media supply 32 and a secondary media supply 34. Materials handling system 30 picks materials from a plurality of media stacks 36A, 36B and 36C. Media stack 36A can be stored within primary media supply 32. Media stack 36A includes one or more image forming materials 17A with one or more slip-sheets 40A. Interspersed between each of the image forming materials 17A is a slip-sheet 40A. It is to be noted that media stacks 36A, 36B and 36C show separations between image recordable materials 17A, 17B, and 17C and slip sheets 40A, 40B and 40C. These separations (along with the separations shown in other Figures) are shown for clarity, and those skilled in the art will realize that contact between the various sheets is typically present within the media stacks 36A, 36B and 36C.

In this embodiment, image recording materials 17A and slip-sheets 40A are stacked alternately and a slip-sheet 40A is arranged on top of media stack 36A. Media stack 36A can include a plurality of media stacks wherein each media stack contains one or more of image recordable material 17A and slip-sheet 40A. Media stack 36A is supported by media holder 42. Media holder 42 can include any suitable support system for media stack 36A, including, but not limited to, cassettes, magazines, or pallets. Pallets are particularly beneficial when media stack 36A includes a large number of image recording materials 17A such as, for example, aluminum offset printing plates. For instance, newspaper printing applications typically have high printing plate making demands. Consequently, a large uninterrupted supply of a large number of printing plates can be needed. Many plates weighing hundreds of kilograms can be required. Pallets provide a suitable means to support such quantities.

Media stack 36A is transported into primary media supply 32 via access port 44 by a cart, pallet-jack, forklift or the like. Access port 44 is closable by one or more covers (not shown). In this embodiment, media stack 36A remains stationary in primary media supply 32 when image recordable materials 17A and slip-sheets 40A are removed from media stack 36A. Media stack 36A remains stationary in primary media supply 32 when image recordable materials 17B and 17C and slip-sheets 40B and 40C are removed from media stacks 36B and 36C, respectively. A stationary media stack is particularly advantageous when the stack is high due to a large numbers of image recordable materials. Moving media holder 42 into an imaging position (or other positions) can cause an associated stack of media to shift due to accelerations/decelerations associated with the movement. A shifted media stack can lead to picking errors.

Secondary media supply 34 includes a media holder 60 and 62. Other embodiments of this invention can employ a different number of media holders. Media holder 60 contains media stack 36B that includes one or more of image recordable material 17B stacked one upon the other and media holder 62 contains media stack 36C that includes one or more of image recordable materials 17C stacked one upon the other. Interspersed between each of the image recording materials 17B and 17C are corresponding slip-sheets 40B and 40C, respectively. In this embodiment of the invention, image recordable materials 17B and 17C and slip-sheets 40B and 40C in each of media stack 36B and 36C, respectively, are stacked alternately and a slip-sheet is positioned on top of each of the stacks 36B and 36C. Each of media stacks 36B and media stacks 36C can include a plurality of image recordable material 17B and 17C and slip-sheets 40B and 40C. Each of media stacks 36B and media stacks 36C can include a plurality of media stacks.

Media holders 42, 60 and 62 can hold materials with similar or dissimilar characteristics. Material differences can include differences in size and/or composition. Differences in the image recordable materials 17A, 17B and 17C may be required by different print jobs. Alternatively, plate-making delays can be avoided by creating additional capacity by arranging one or more of the media holders 42, 60 and 62 to contain image recordable materials 17A, 17B and 17C, respectively, with the same characteristics as those contained in an additional media holder.

In this embodiment, as seen in FIG. 1, media holder 42 is arranged so that media stack 36A is continuously available to have materials removed from it. Media holder 42 assumes both a storage position and a materials removal position within primary media supply 32. Guides 64 and 66 allow media holders 60 and 62 to be moved from a storage position within secondary media supply 34 to a materials removal position within primary media supply 32. For example, when controller 23 determines that image recordable material 17B is required for a plate making operation, controller 23 sends a signal to a drive mechanism (not shown) associated with media holder 60. The drive mechanism causes media holder 60 to move from secondary media supply 34 along guides 64 into primary media supply 32. The drive mechanism can, for example, include an electrical motor, pulleys and/or timing belts. Those skilled in the art will appreciate that in other embodiments, the drive mechanism may comprise components such as, for example, pneumatic or hydraulic cylinders, chains, gears and other suitable drives. When media holder 60 is positioned in primary media supply 32, picking assembly 70 can remove slip-sheets 40B and image recordable materials 17B from media holder 60. In this illustrated example embodiment, controller 23 provides signals to ensure that when slip-sheets 40B and image recordable materials 17B are to be removed from media holder 60 positioned within primary media supply 32, an additional media holder will not be positioned above media holder 60 within primary media supply 32. An additional media holder positioned above a given media holder within primary media supply 32 can obstruct materials pickers 50 and slip-sheet pickers 55 from removing materials from the given media holder.

In this embodiment, controller 23 can provide and receive signals to allow an additional media holder to be positioned below a given media holder within primary media supply 32, such that slip-sheets and image recordable materials can be removed from the given media holder. An additional media holder positioned below a given media holder within primary media supply 32 does not obstruct picking assembly 70 from removing materials from the given media holder. A detailed description of an example method of operation of a recording system 10 of the type described here is provided in commonly-assigned copending U.S. patent application Ser. No. 11/668,519, which is hereby incorporated in full.

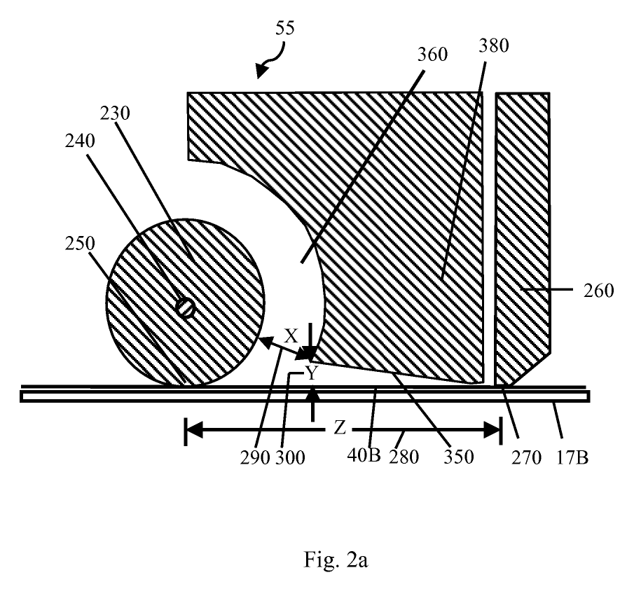

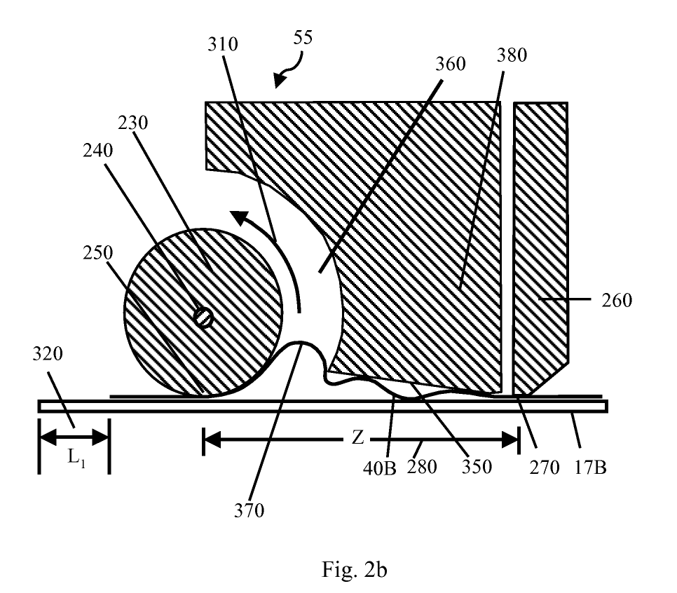

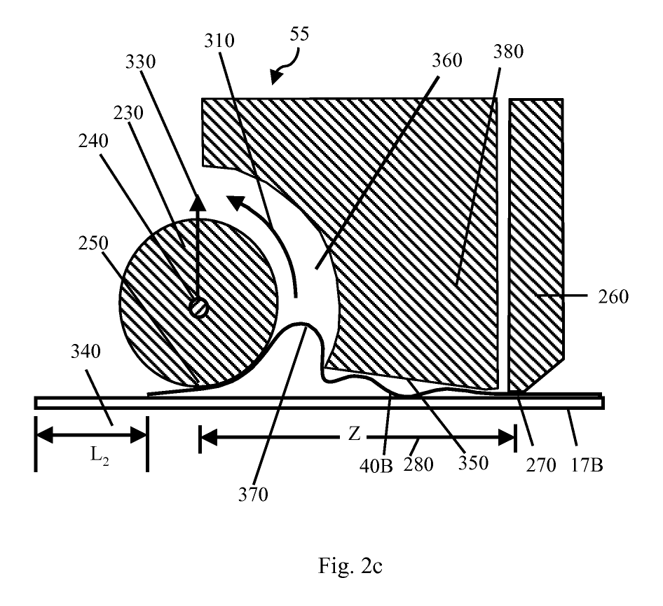

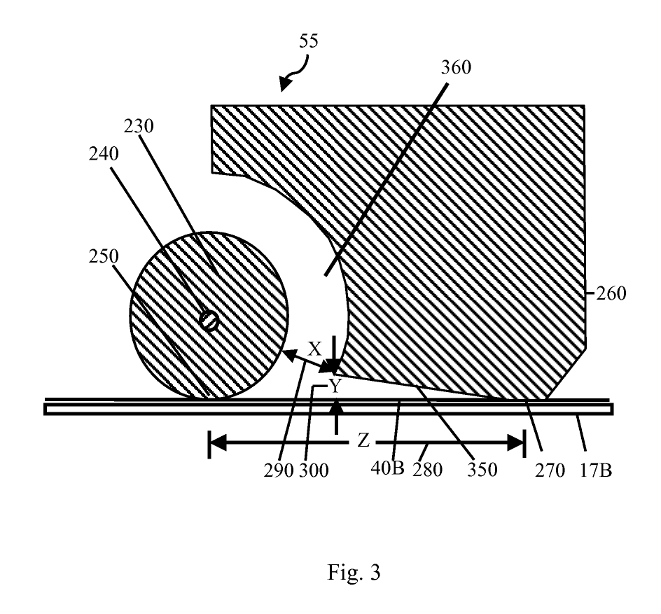

FIGS. 2a, 2b and 2c show schematic cross-sectional views of slip-sheet picker 55 in contact with slip-sheet 40B on image recordable material 17B as per an example embodiment of the invention. Slip-sheet picker 55 comprises retraction roller 230 rotatably driven about its axis via shaft 240 by a motor (not shown). In FIG. 2a retraction roller 230 is shown in contact at retraction roller contact point 250 with slip-sheet 40B on image recordable material 17B. Slip-sheet 40B is nipped between retraction roller 230 and image recordable material 17B. Slip-sheet picker 55 further comprises a slip-sheet holding member in the form of slip-sheet picker foot 260. In FIG. 2a slip-sheet picker foot 260 is shown in contact at pressure point 270 with slip-sheet 40B on image recordable material 17B. Slip-sheet 40B is nipped between slip-sheet picker foot 260 and image recordable material 17B. Pressure point 270 is located where slip-sheet picker foot 260 is in contact with slip-sheet 40B on image recordable material 17B. Slip-sheet picker 55 further comprises a slip-sheet guide member 380 having slip-sheet guide surface 350 generally forming the surface of slip-sheet guide member 380 proximate and facing image recordable material 17B and slip-sheet 40B. In other example embodiments shown in FIG. 3, slip-sheet guide member 380 and picker foot 260 can be one component such that slip-sheet guide surface 350 is a surface of slip-sheet foot 260.

Returning to FIGS. 2a, 2b and 2c, slip-sheet picker foot 260 and retraction roller 230 can be manufactured from suitable material including, but not limited to elastomers (e.g. silicone) or other suitable materials that can provide a suitable friction coefficient with slip-sheet 40B that is greater than the static friction coefficient between slip-sheet 40B and image recordable material 17B at the range of pressures that retraction roller 230 exerts on slip-sheet 40B and image recordable material 17B during operation of slip-sheet picker 55. The friction characteristics of retraction roller 230 material can vary as a function of durometer, tackiness and other attributes of the material.

Slip-sheet guide member 380 is offset from retraction roller 230 by a distance 290, denoted by X, and described in the present specification by the term “roller gap.” The arrangement of the roller gap is not limited to being a cylindrical section as shown in FIG. 2a. In this illustrated embodiment, the roller gap between the surface of retraction roller 230 and slip-sheet guide member 380 is substantially constant along the axis of retraction roller 230 for any given point on the periphery of the cross-section of retraction roller 230. The term “folding length” is used in the present specification to describe the distance, denoted by Z, between pressure point 270 and roller contact point 250. The term “confinement height” is used in the present specification to describe the distance Y between image recordable material 17B and the point where slip-sheet guide surface 350 most closely approaches retraction roller 230, as shown in FIG. 2b. The term “slip-sheet channel” is used in the present specification to describe the channel 360 that exists between retraction roller 230 and slip-sheet guide member 380.

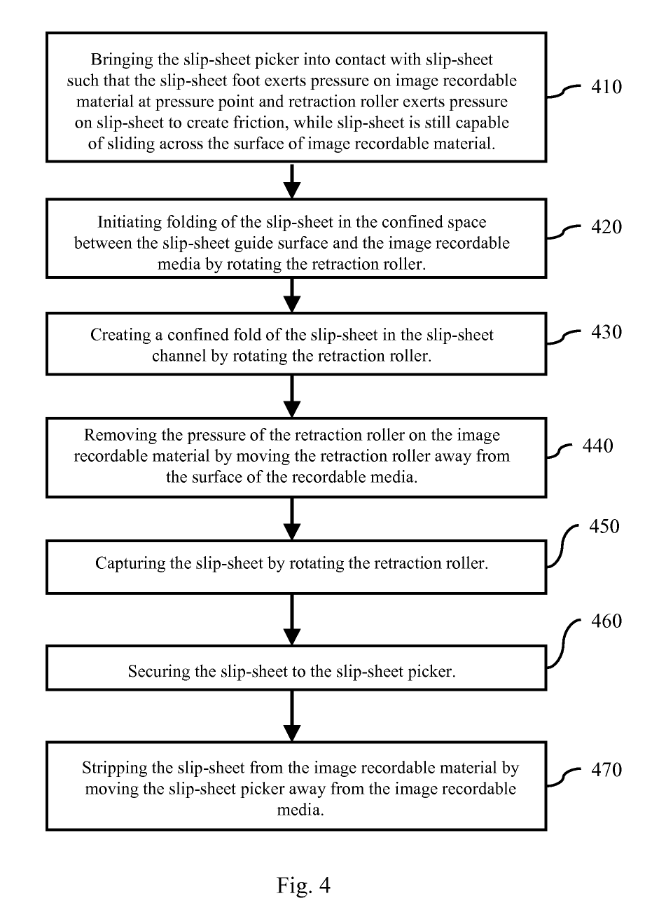

In operation, the slip-sheet picker 55 of the present invention proceeds as follows to remove slip-sheet 40B from the surface of image recordable material 17B on which slip-sheet 40B resides (see FIGS. 2a, 2b, 2c and the flow diagram of FIG. 4):

As shown in FIG. 2a and FIG. 4, the method comprises the bringing into contact (410) of the slip-sheet picker 55 with slip-sheet 40B residing on a surface of image recordable material 17B. In this step, both retraction roller 230 and slip-sheet picker foot 260 are placed in contact with slip-sheet 40B and pressure is applied such that an advantageous degree of friction exists between retraction roller 230 and slip-sheet 40B, while slip-sheet 40B is still capable of sliding across the surface of image recordable material 17B in the region proximate retraction roller 230. Adequate pressure is also applied to ensure that slip-sheet picker foot 260 presses down on pressure point 270 with adequate force to pin or nip slip-sheet 40B at that point and prevent it from sliding across the surface of image recordable material 17B at pressure point 270.

As shown in FIG. 2b and FIG. 4, retraction roller 230 is then rotated about shaft 240 in rotation direction 310, thereby initiating folding (420) of the slip-sheet 40B in the confined space between the slip-sheet guide surface 350 and the image recordable media 17B. More particularly, due to the friction between retraction roller 230 and slip-sheet 40B, and the relatively lower friction between slip-sheet 40B and image recordable material 17B at roller contact point 250, slip-sheet 40B will start to buckle or fold as shown in FIG. 2b. As shown in FIG. 2b, other smaller folds may also be additionally formed. However, the confined space between the slip-sheet guide surface 350 and the image recordable media 17B suppresses folding of slip-sheet 40B in the region proximate pressure point 270. The amount of rotation is intentionally kept exceedingly small and just adequate to create a fold 370 in slip-sheet 40B that enters slip-sheet channel 360. To the extent that fold 370 is intentionally being confined mechanically to be and grow proximate retraction roller 230, it is referred to in the present specification as a “confined fold.” The size X of roller gap 290 is chosen such that slip-sheet 40B does not crease when entering roller gap 290, but, instead, folds so as to develop a spring force that keeps slip-sheet 40B pressing against retraction roller 230 with enough magnitude to maintain the static friction between retraction roller 230 and slip-sheet 40B despite the fact that slip-sheet 40B is not backed by image recordable material 17B in those areas of slip-sheet 40B that have folded away from image recordable material 17B. This process may be viewed as comprising firstly initiating folding (420) or buckling slip-sheet 40B in the confined gap between slip-sheet guide surface 350 and recordable media 17B, and secondly creating (430) a confined fold 370 of slip-sheet 40B into slip-sheet channel 360, both by rotating retraction roller 230.

The required friction force created between retraction roller 230 and slip-sheet 40B can vary as function of the size of the folding length 280 (Z). Typically, the magnitude of the friction force in the plane of image recordable material 17B required to buckle slip-sheet 40B and separate it from image recordable material 17B will be reduced with increasing folding lengths 280 (Z). Reduced friction forces in turn allow for a reduction of the pressure of retraction roller 230 on image recordable material 17B that is required to buckle slip-sheet 40B. The potential to chafe or otherwise damage the modifiable surface of image recordable material 17B is thereby advantageously lessened.

Slip-sheet guide surface 350 is arranged to form a confined narrow channel or space between itself and image recordable material 17B. In the illustrated example, slip-sheet guide surface 350 is tapered to form a very acute angle with the surface of image recordable material 17B between pressure point 270 and retraction roller contact point 250. By employing a relatively long folding length 280 (Z), along with a tapered slip-sheet guide surface 350, the inventors obtain smooth, consistent and lower force upon retraction roller 230 on initiation of the folding process described herein.

It should be noted that too much folding over a comparatively long folding length (Z) will cause the required rotation of retraction roller 230 for a given size of fold 370 to be quite large. Smaller rotations of retraction roller 230 are however desired since they can further lessen damage to the modifiable surface of image recordable material 17B by reducing the distance that any resulting chaffing forces act along the surface of image recordable material 17B. Smaller rotations of retraction roller 230 can however result in a wide and shallow fold with little curvature and a height that is insufficient to properly engage slip-sheet channel 360. As result, the angle between slip-sheet guide surface 350 and the surface of image recordable material 17B is kept very acute by keeping confinement height 300 (Y), small, thereby confining slip-sheet 40B and keeping it from folding significantly between slip-sheet guide surface 350 and the surface of image recordable material 17B. Slip-sheet 40B is therefore constrained to form confined fold 370 in a region in the vicinity of retraction roller 230. In this illustrated embodiment, slip-sheet 40B is constrained to form confined fold 370 into slip-sheet channel 360. A confined fold 370 of suitable size can thereby be made for a very small amount of rotation by retraction roller 230. Confined fold 370 has enough elastic spring force to keep slip-sheet 40B pressing against retraction roller 230 as slip-sheet 40B folds into slip-sheet channel 360. In this initial process, slip-sheet 40B is retracted by a retraction length (L₁) 320. The combining of a long folding length Z with a small confinement height Y results in:
(i) a lower retraction roller force needed to initiate folding,
(ii) a suitably sized confined fold 370 of slip-sheet 40B locally formed in the vicinity of slip-sheet channel 360 for a very small amount of rotation of retraction roller 230,
(iii) enough friction between the large confined fold 370 of slip-sheet 40B and retraction roller 230 such that capturing of slip-sheet 40B, as described below, can proceed even if retraction roller 230 is raised in direction 330 (See FIG. 2c and FIG. 4) away from image recordable material 17B to eliminate a nip between retraction roller 230 and image recordable material 17B, and
(iv) a reduction in the potential to damage various surfaces of image recordable material 17B (for example, the very sensitive modifiable surface) due to chafing by slip-sheet 40B as it is initially retracted from the image recordable material 17B. In particular, damage caused by chafing is reduced by employing longer long folding length 280 (Z) to reduce friction forces. Slip-sheet guide surface 350 is employed to localize and focus the resulting fold formed in slip-sheet 40B, thereby reducing the required rotation of retraction roller 230 which minimizes the distance that any chafing forces are applied along the surface of recordable material 17B.

When confined fold 370 has been formed to a suitable size in slip-sheet channel 360, the method proceeds by removing (440) the pressure of retraction roller 230 on the image recordable material 17B by moving retraction roller 230 away from image recordable material 17B and rotating retraction roller 230 along direction 310. In this illustrated embodiment, retraction roller is moved away from image recordable material 17B along direction 330, although it is understood that retraction roller 230 can move away from image recordable material 17B along other directions. In this second phase, slip-sheet 40B is retracted for an accumulated retraction length 340 of (L₂). Advantageously, since retraction roller 230 is no longer pressing slip-sheet 40B against image recordable material 17B, potential damage to the modifiable surface of image recordable material 17B is lessened as slip-sheet 40B is further retracted. The spring force created by previously formed confined fold 370 allows for sufficient friction force between retraction roller 230 and slip-sheet 40B to further fold slip-sheet 40B into slip-sheet channel 360 during the rotation (440).

In one embodiment of the present invention, a suitably large confinement fold 370 is formed, after which the rotation of retraction roller 230 is stopped and the pressure of retraction roller 230 on the image recordable material 17B is removed by moving retraction roller 230 away from image recordable material 17B before rotation of retraction roller 230 is resumed.

In other embodiments of the present invention the rotation of retraction roller 230 is maintained after a suitably large confinement fold 370 has been formed, and the pressure of retraction roller 230 on the image recordable material 17B is removed by moving retraction roller 230 away from image recordable material 17B while that rotation is simultaneously maintained.

The complete capturing (450) of slip-sheet 40B may then proceed by the further rotation of retraction roller 230. This is followed by the securing (460) of slip-sheet 40B to slip-sheet picker 55. In some example embodiments of the invention, the securing of slip-sheet 40B to slip-sheet picker 55 is via the spring force exerted by the fold 370 within slip-sheet channel 360. In some example embodiments of the invention, the securing of slip-sheet 40 is by clamping a surface of fold 370 against a support (e.g. retraction roller 230). Various auxiliary securement mechanisms and securement members can be used to secure slip-sheet 40B and can include without limitation, grippers, clamps, suction or pressure sources and the like. In some example embodiments of the invention, retraction roller 230 can rotate to cause fold 370 to unfold itself within slip-sheet channel 360. An example of this unfolding is described in commonly-assigned copending U.S. patent application Ser. No. 11/668,519. Portions of fold 370 which is subsequentially unfolded can additionally be secured.

When slip-sheet 40B has been secured to slip-sheet picker 55, slip-sheet picker 55 can be distanced away from the media stack, stripping (470) slip-sheet 40B from image recordable material 17B in the process.

With slip-sheet 40B secured, and slip-sheet picker 55 having moved slip-sheet 40B away form the media stack, exposed portions of image recordable material 17B can be secured by materials picker 50 in various ways. An example of a materials picker 50 is described in commonly-assigned copending U.S. patent application Ser. No. 11/668,519. Once image recordable material 17B has been secured, materials picker 50 can move image recordable material 17B away from the media stack. In some example embodiments of the invention, slip-sheet 40B and image recordable material 17B are moved away from the media stack sequentially. In some example embodiments of the invention, slip-sheet 40B and image recordable material 17B are moved away from the media stack concurrently. The image recordable material 17B and the slip-sheet 40B can be moved simultaneously along a conveying path to a subsequent process. Slip-sheet 40B can be removed from image recordable material at a location along the conveying path.

It has been observed that, for a confinement height Y of 10 mm, the retraction length L2 required to consistently capture a slip sheet was 20 mm. By reducing confinement height Y to 6.5 mm, the retraction length L2 required to consistently capture a slip sheet was reduced to 13 mm. Employing a 40 mm wide slip-sheet and a constant normal force of a roller on that slip-sheet, the inventors found that, for a folding length Z of 20 mm, the force along the surface of the slip-sheet required to buckle the slip-sheet was 0.35 lbs. Increasing the folding length Z to 30 mm led to a significantly lower force of 0.31 lbs being required to buckle the slip-sheet, while further increasing Z to 60 mm further reduced the required force for buckling the slip-sheet to 0.27 lbs. This clearly demonstrates the reduction in forces and the reduction in retraction length effected by the present invention, both leading to significantly reduced potential for chafing on and damage to the image recordable material on which the slip-sheet is arranged.

The invention has been described in detail with particular reference to certain preferred embodiments thereof, but it will be understood that variations and modifications can be effected within the scope of the invention.

### PARTS LIST

10 image recording system
11 roller
12 housing
15 exposure system
16 exposure support
17 image recordable material
17A image recordable material
17B image recordable material
17C image recordable material
18 imaging head
19 radiation beams
20 leading edge clamps
21 trailing edge clamps
22 loading support
23 controller
24 drive
25 main-scan direction
26 slip-sheet holder
27 unloading support
28 first position
29 second position
30 materials handling system
32 primary media supply
34 secondary media supply
36A media stacks
36B media stacks
36C media stacks
40A slip-sheets
40B slip-sheets
40C slip-sheets
42 media holder
44 access port
50 material pickers
55 slip-sheet picker
60 media holder
62 media holder
64 guide
66 guide
70 picking assembly
230 retraction roller
240 shaft
250 retraction roller contact point
260 slip-sheet picker foot
270 pressure point
280 folding length, Z
290 roller gap, X
300 confinement height, Y
310 rotation direction
320 retraction length, L₁
330 direction
340 retraction length, L₂
350 slip-sheet guide surface
360 slip-sheet channel
370 confined fold
380 guide member
410 bringing the slip-sheet picker into contact with slip-sheet
420 initiating folding of the slip-sheet
430 creating a confined fold of the slip-sheet
440 removing the pressure of the retraction roller
450 capturing the slip-sheet by rotating the retraction roller
460 securing the slip-sheet to the slip-sheet picker
470 stripping the slip-sheet from the image recordable material

1. A method for separating a slip-sheet from an image recordable medium, the method comprising:
bringing a slip-sheet picker into contact with the slip-sheet, a first portion of the slip-sheet picker exerting pressure on the image recordable material at a first point;
exerting with a retraction roller portion of the slip-sheet picker pressure on the slip-sheet at a second point;
initiating folding of the slip-sheet in a confined space between the slip-sheet picker and the image recordable media by rotating the retraction roller; and
capturing the slip-sheet by rotating the retraction roller.

2. The method of claim 1, comprising creating a confined fold in the slip-sheet proximate the retraction roller.

3. The method of claim 2, wherein the retraction roller stops exerting pressure on the image recordable material during the creation of the confined fold.

4. The method of claim 3, wherein the retraction roller stops exerting pressure on the image recordable material by being moved away from the image recordable material.

5. The method of claim 1 comprising:
securing the slip-sheet to the slip-sheet picker; and
stripping the slip-sheet from the image recordable material.

6. The method of claim 5, wherein the stripping is by distancing the slip-sheet picker away from the image recordable media.

7. A slip-sheet picker for separating a slip-sheet from an image recordable medium comprising:
a holding member for exerting pressure on the image recordable material at a first point;
a slip-sheet guide member arranged to form a confined space between the slip-sheet guide member and the image recordable material; and
a retraction roller for exerting pressure on the image recordable material at a second point, the retraction roller being capable of stopping the exerting pressure on the image recordable material while the holding member continues exerting pressure on the image recordable material.

8. The slip-sheet picker of claim 7, wherein the holding member and retraction roller are configured to create a confined fold in the slip-sheet proximate the retraction roller and the slip-sheet guide member is configured to suppress folding in the slip-sheet in the region proximate the first point when both the holding member and the retraction roller are in contact with the slip-sheet and both the holding member and the retraction roller are exerting pressure on the image recordable material.

9. The slip-sheet picker of claim 8, further comprising a securement member for securing the slip-sheet to the slip-sheet picker.

10. The slip-sheet picker of claim 8, wherein the holding member and the slip-sheet guide member are one member.

11. A method for separating a slip-sheet from an image recordable medium, the method comprising:
bringing a slip-sheet picker into contact with the slip-sheet, a first portion of the slip-sheet picker exerting pressure on the image recordable material at a first point;
exerting with a second portion of the slip-sheet picker pressure on the slip-sheet at a second point, the second portion being movable with respect to the first portion;
initiating folding of the slip-sheet in a confined space between the slip-sheet picker and the image recordable media by moving the second portion; and
capturing the slip-sheet.

12. The method of claim 11, comprising creating a confined fold in the slip-sheet proximate the second portion.

13. The method of claim 12, wherein the second portion stops exerting pressure on the image recordable material during the creation of the confined fold.

14. The method of claim 13, wherein the second portion stops exerting pressure on the image recordable material by being moved away from the image recordable material.

15. The method of claim 11 comprising:
securing the slip-sheet to the slip-sheet picker; and
stripping the slip-sheet from the image recordable material.

16. The method of claim 15, wherein the stripping is by distancing the slip-sheet picker away from the image recordable media.
